(19) United States
(12) Patent Application Publication
(10) Pub. No.: US 2017/0078850 A1
(43) Pub. Date: Mar. 16, 2017

(54) PREDICTING LOCATION-BASED RESOURCE CONSUMPTION IN MOBILE DEVICES

(71) Applicant: International Business Machines Corporation, Armonk, NY (US)

(72) Inventors: James E. Bostick, Austin, TX (US); John M. Ganci, JR., Cary, NC (US); Martin G. Keen, Cary, NC (US); Sarbajit K. Rakshit, Kolkata (IN)

(73) Assignee: International Business Machines Corporation, Armonk, NY (US)

(21) Appl. No.: 14/853,083

(22) Filed: Sep. 14, 2015

(51) Int. Cl. H04W 4/02

(52) U.S. Cl. CPC H04W 4/028

(57) ABSTRACT

For predicting resource usage in a mobile device, a historical usage data of a second mobile device is analyzed at a present time, the historical usage data resulting from a usage of the second mobile device at a location at a previous time. A previous consumption of a resource of the second mobile device is computed using the historical usage data. A variable condition is selected where the variable condition is specific to the location. A weight is applied to the variable condition to form a weighted variable in a prediction model. Using the prediction model, the previous consumption of the resource is adjusted according to the weighted variable to form a predicted consumption of the resource. The location and the predicted consumption of the resource are plotted on a graphical map.

### TECHNICAL FIELD

The present invention relates generally to a method, system, and computer program product for managing the computing resources available on a mobile device. More particularly, the present invention relates to a method, system, and computer program product for predicting location-based resource consumption in mobile devices.

### BACKGROUND

Wireless communications (mobile communications) enable users to perform a variety of tasks using their mobile devices. An ever increasing number of applications is available for the wireless data processing systems, wireless data communication devices, or wireless computing platforms (collectively and interchangeably, “mobile device” or “mobile devices”). For example, many mobile devices not only allow the users to make voice calls, but also exchange emails and messages, access remote data processing systems, and perform web-based interactions and transactions.

Wearable devices are a category of mobile devices. A wearable device is essentially a mobile device, but has a form-factor that is suitable for wearing the device on a user's person. A user can wear such a device as an article of clothing, clothing or fashion accessory, jewelry, a prosthetic or aiding apparatus, an item in an ensemble, an article or gadget for convenience, and the like. Some examples of presently available wearable devices include, but are not limited to, smart watches, interactive eyewear, devices embedded in shoes, controllers wearable as rings, and pedometers.

Some wearable devices are independent wearable devices in that they can operate as stand-alone mobile devices. Such a wearable device either includes some or all the capabilities of a mobile device described above or does not need or use the capabilities of a mobile device described above.

Other wearable devices are dependent wearable devices in that they operate in conjunction with a mobile device. Such a wearable device performs certain functions while in communication with a mobile device described above.

In performing these functions, mobile devices consume resources. Some non-limiting examples of the resources consumed by a mobile device include an amount of the power from the battery of the mobile device, an amount of data received and/or transmitted over a cellular data network according to a data subscription, an amount of data received and/or transmitted over a Wi-Fi network, an amount of storage space used to store data, an amount of time the mobile device is used according to a subscription plan, and the like.

### SUMMARY

The illustrative embodiments provide a method, system, and computer program product for predicting location-based resource consumption in mobile devices. An embodiment includes a method for predicting resource usage in a mobile device. The embodiment analyzes, at a present time, a historical usage data of a second mobile device, the historical usage data resulting from a usage of the second mobile device at a location at a previous time. The embodiment computes a previous consumption of a resource of the second mobile device using the historical usage data. The embodiment selects a variable condition, wherein the variable condition is specific to the location. The embodiment applies a weight to the variable condition to form a weighted variable in a prediction model. The embodiment adjusts, using the prediction model, to form a predicted consumption of the resource, the previous consumption of the resource according to the weighted variable. The embodiment plots, on a graphical map, the location and the predicted consumption of the resource.

Another embodiment includes a computer program product for predicting resource usage in a mobile device, the computer program product comprising one or more computer-readable storage devices, and program instructions stored on at least one of the one or more storage devices.

Another embodiment includes a system for predicting resource usage in a mobile device, the computer system comprising one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for predicting location-based resource consumption in mobile devices in accordance with an illustrative embodiment;

FIG. 4 depicts an example plot of a resource usage prediction on a graphical map in accordance with an illustrative embodiment;

FIG. 5 depicts another example plot of a resource usage prediction on a graphical map in accordance with an illustrative embodiment;

FIG. 6 depicts a flowchart of an example process for predicting location-based resource consumption in mobile devices in accordance with an illustrative embodiment; and

FIG. 7 depicts a flowchart of an example process for self-learning in accordance with an illustrative embodiment.

### DETAILED DESCRIPTION

The illustrative embodiments recognize that at least some resources available to a computing device are available to the device in only limited quantities. This is particularly true of mobile devices, where resources such as battery power and storage space are significantly limited.

The quantities of many other resources can be limited on mobile devices in a similar manner. For example, a mobile device can be limited in how much data the device can send and/or receive during a specified period over a cellular service provider's network. Similarly, a mobile device can be limited in how much data the device can send and/or receive during a specified period, or for how long the device can remain connected to a publicly available Wi-Fi network. Therefore, the illustrative embodiments recognize that these and other resources have to be carefully managed on a mobile device.

Furthermore, the illustrative embodiments recognize that the resource consumption of a mobile device is dependent not only upon the operations performed but also on a location from where those operations are performed. Within the scope of the illustrative embodiments, a location includes not only a precisely defined point, but also a geographical area of a size and bound in any suitable manner in a three dimensional geographical space.

For example, a mobile device consumes the storage resource for storing photographs whenever a photograph is captured in the normal course of a user using the device. However, when the user visits a location of interest, such as a museum, where the user is inclined to capture higher than a normal number of photographs, thereby consuming higher than a normal number of storage space.

As another example, a mobile device consumes the power resource for connecting to a preferred cellular network over a preferred protocol, e.g., 4G LTE, from a location the user routinely visits. However, when the user visits a different location, such as during the user's travels, the user may have to operate on a different network using a different protocol, e.g., 2G or 3G, due to the availability of cellular networks at that location. The mobile device is likely to consume more of the power resource when operating on a 2G or 3G network as compared to when the device operates on 4G LTE network, for performing the same operation.

As another example, a mobile device consumes the power resource for routine use by the user. However, when the user visits a different location, such as during the user's travels, the user may be inclined to overuse the device, such as for increased social media messaging, increased uploads, higher use of the flashlight feature, higher use of the navigation applications, greater dependency on the mobile device due to a lack of alternative communication devices at the location, and many other reasons. The mobile device is likely to consume more of the power resource and other resources simply due to an increased use of the mobile device at the location.

The illustrative embodiments recognize that mobile devices deplete the resources at different rates, consume different amounts of resources, or end up with different amounts of reserves at different locations. For example, users often find themselves modifying their usage patterns unexpectedly when the device's battery depletes faster when they are traveling and do not have access to recharging equipment or outlet. As another example, users are often surprised at how quickly their device's storage space filled up when they were clicking away at their tourist destinations.

The illustrative embodiments recognize that users are often dependent upon their own intuition and experience, which is often inadequate, in planning for the resource consumption of their mobile devices at different locations. Presently available methods are limited to considering the user's current usage pattern at a given time to project how much more use of that resource the user can expect at the current usage level. Such projections are inadequate to inform the user about the possible resource usage scenario at a different time and location, where that possible resource usage scenario might be significantly different from the user's current usage scenario. The presently available methods for resource management on mobile devices are unable to determine how the usage of the device will change with changing locations, times, types of attractions or opportunities for device usage, seasonality, weather, and several other factors.

The illustrative embodiments used to describe the invention generally address and solve the above-described problems and other problems related to managing resources on a mobile device. The illustrative embodiments provide a method, system, and computer program product for predicting location-based resource consumption in mobile devices.

An embodiment receives a location of operation of the mobile device. For example, in some cases, a user may specify to the mobile device in some suitable manner that the user will be going to Rome next week. In some other cases, the mobile device may detect, such as via the location coordinates provided by the Global Positioning System (GPS) module of the mobile device, that the device is in Rome and therefore will be operating in Rome.

An embodiment determines whether the user has operated the mobile device at the location before. For example, the user may have previously been in Rome and the usage pattern or usage data from that visit may be available to the embodiment. If data of a previous usage of the mobile device at the location is not available for the given user or mobile device, the embodiment determines whether usage data of any other user is available from such other user's use of another mobile device at the location.

Based on an analysis of the user's own historical usage data or another user's historical usage data, the embodiment predicts an expected duration of the planned usage at the location. For example, if the user spent three hours at the location according to the historical usage data, the expected duration of the planned visit may be comparable as well. As another example, if the historical usage patterns of several users show that users often spend three to five hours at and around the location, the expected duration for the planned visit might be an average of the durations from the other users' data.

For each resource that its consumable at the location, the embodiment further uses the analysis to compute an amount of the resource that is expected to be consumed during the planned visit. For example, if the user's own historical usage data shows that the user expended 55 watts—approximately 70 percent—of the battery power, filled approximately 2 Gigabytes (GB) of storage space with pictures, remained connected to a roaming 3G network for approximately 3 hours, and transmitted or received approximately 400 Megabytes of data during that period, those resources are likely to be consumed in similar quantities during the planned visit. As another example, if the user has no usage data for the location but other users' historical usage data shows that on average users expended 50 watts—approximately 65 percent in terms of the user's battery—of the battery power, filled approximately 2.5 GB of storage space with pictures, remained connected to a roaming 3G network for approximately 3.5 hours, and transmitted or received approximately 200 Megabytes of data during that period, those resources are likely to be consumed in similar quantities during the planned visit.

Once the embodiment has computed the expected consumption amounts of the various resources, the embodiment further adjusts the computed amounts according to one or more variables. For example, a resource consumption might be increased or reduced depending upon the type of cellular network—an example variable—available at the location during the planned visit for the reasons described earlier. As another example, the consumption of a resource may change depending upon whether public Wi-Fi access—another example variable—is going to be available during the planned visit. Similarly, many other variables, such as the season, the weather, the traffic conditions, closure or opening of an attraction at the location, special events at the location, and the like can change the resource consumption during the planned visit.

The embodiment receives from a data source information about a variable for a location and duration of the planned visit. For example, a source provides the cellular coverage information that is applicable for the location and period of the visit. As another example, another source provides the availability information of public access Wi-Fi during the visit. As another example, another source provides the weather forecast during the visit. As another example, another source provides the traffic forecast during the visit. As another example, another source provides the schedule of events during the visit.

The embodiment assigns a weight to each variable that is used in the prediction of the resource consumption. For example, in the summer season, the usage of storage is expected to increase due to a longer visit as compared to in the winter months, and therefore, the season variable carries a suitable weight to increase the expected storage resource consumption. As another example, if the cellular coverage is expected to be downgraded, the power consumption is likely to increase, and therefore, the cellular coverage data carries a suitable weight to adjust or increase the expected power resource consumption accordingly. As another example, if the public Wi-Fi access is expected to be available, the power consumption is likely to decrease, and therefore, the Wi-Fi availability data carries a suitable weight to adjust or decrease the expected power resource consumption accordingly.

These examples of the resources, the variables, the effects of certain variable on the consumption of certain resources, weights, and adjustments are not intended to be limiting. From this disclosure, those of ordinary skill in the art will be able to conceive many other variations of these aspects, and the same are contemplated within the scope of the illustrative embodiments.

The embodiment predicts the resource consumption that can be expected during the planned visit. The prediction adjusts the consumptions, which were computed according to usage data of one or more users, by applying adjustments to the consumptions according to the weighted variables that are expected to be applicable to the location and duration of planned visit.

One embodiment further plots the predicted consumptions on a graphical map. For example, the embodiment outlines the location on an electronic map that can be rendered on the mobile device. The embodiment associates the predicted consumptions with the outline. The data of the prediction, the outline, and the map are rendered together on the mobile device such that the user can visually associate the resource consumption with the location of the planned visit.

In some cases, there might be other locations near the location of the planned visit. According to an embodiment, such other locations may also have predictions about the resource consumptions at those locations. Through zoom-in or zoom-out functions available for the graphical map, the user may be able to view several locations simultaneously on the mobile device. When more than one location is viewable on the map, and when resource consumptions for such other locations is also predicted by an embodiment, the embodiment aggregates the predicted resource consumptions for all locations that can be combined within the view of the map to create a larger location and an aggregated resource consumption prediction therefor. Zooming in can segregate the predictions of various locations and zooming out can aggregate the predictions depending on which locations are in a given zoomed view of the graphical map.

An embodiment measures the actual resource consumption during the visit. The embodiment compares the actual consumption with the predicted consumption to determine a degree of error. The embodiment also collects actual values of a set of variables during the visit and compares the actual values of the variables with the values used in the prediction. Using machine learning techniques for self learning in prediction models, the embodiment adjusts a weight of an existing variable, adds a new variable to the resource consumption prediction model, removes an existing variable from the prediction model, and performs other such changes to reduce the degree of error.

A method of an embodiment described herein, when implemented to execute on a device or data processing system, comprises substantial advancement of the functionality of that device or data processing system in predicting location-based resource consumption in mobile devices. For example, a prior-art method of predicting resource consumption essentially extrapolates a current usage pattern over time to determine how long the remaining resources will last. The prior-art method cannot predict the resource consumption at a different location and subject to various location-dependent variables, user-behavior dependent variables, and the like. An embodiment predicts the resource consumption of a mobile device for a planned visit to a location for an expected or actual duration, subject to location-based variables, user-behavior based variables, or a combination thereof, affecting the resource usage according to a weighted prediction model. Such a manner of predicting resource usage of a mobile device is unavailable in presently available devices or data processing systems. Thus, a substantial advancement of such devices or data processing systems by executing a method of an embodiment is in improving the utility of the mobile device at the location and time of a planned visit by accurately predicting how much resources the mobile device can be expected to consume during the visit.

The illustrative embodiments are described with respect to certain locations, usage data, variables, weights, adjustments, resources, consumptions, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

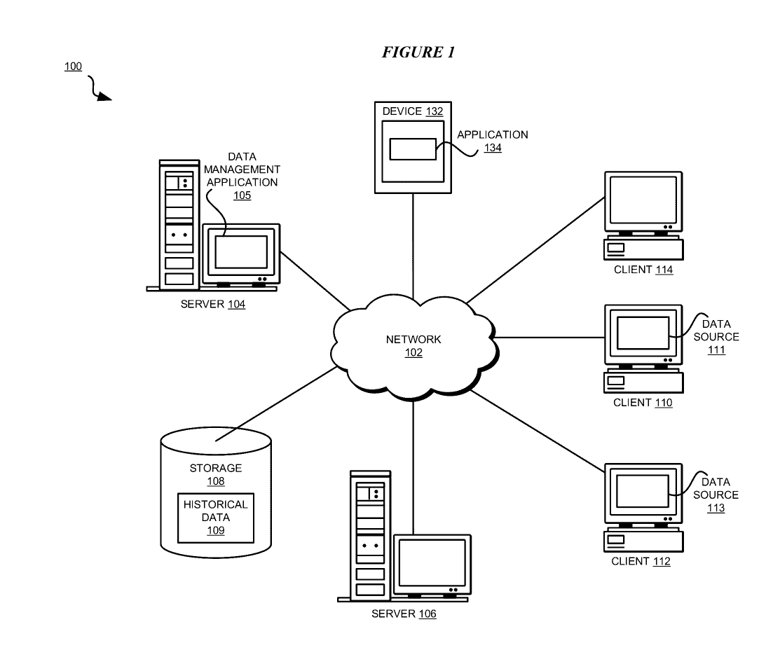

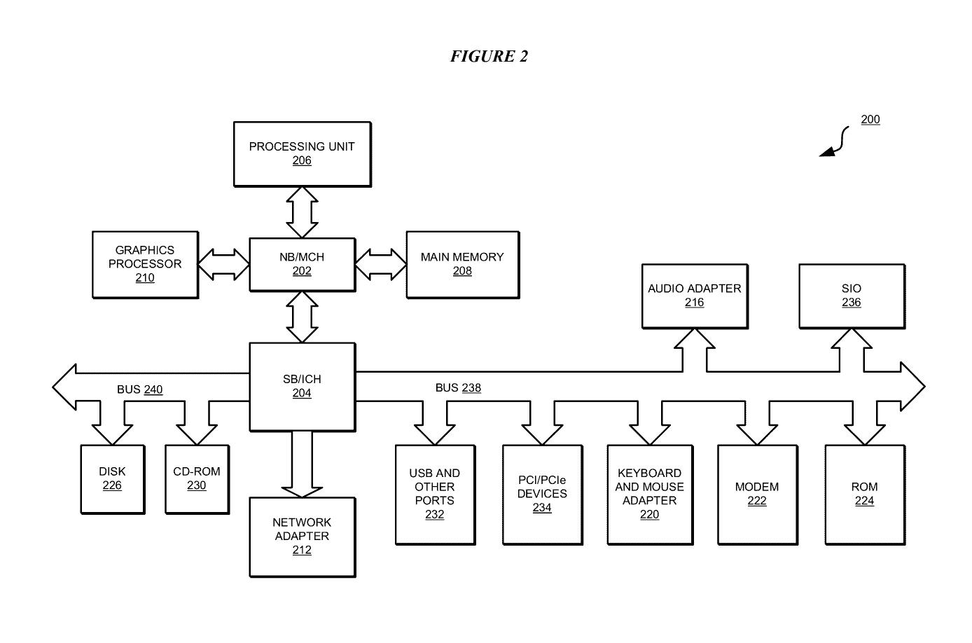

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 134 executes in device 132 and implements an embodiment described herein. Data management application 105 collects usage data from the users during their various visits. Application 105 normalizes or otherwise manipulates the collected data to form historical data 109. Historical data 109 is usable in a manner described herein. Data source 111 may be a source of information about a variable, e.g., a cellular service provider who provides coverage information for use in a manner described herein. Data source 113 and any number of data sources operate to provide information about one or more variables in a similar manner for use in a prediction model.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux° (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as applications 105 and 134 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

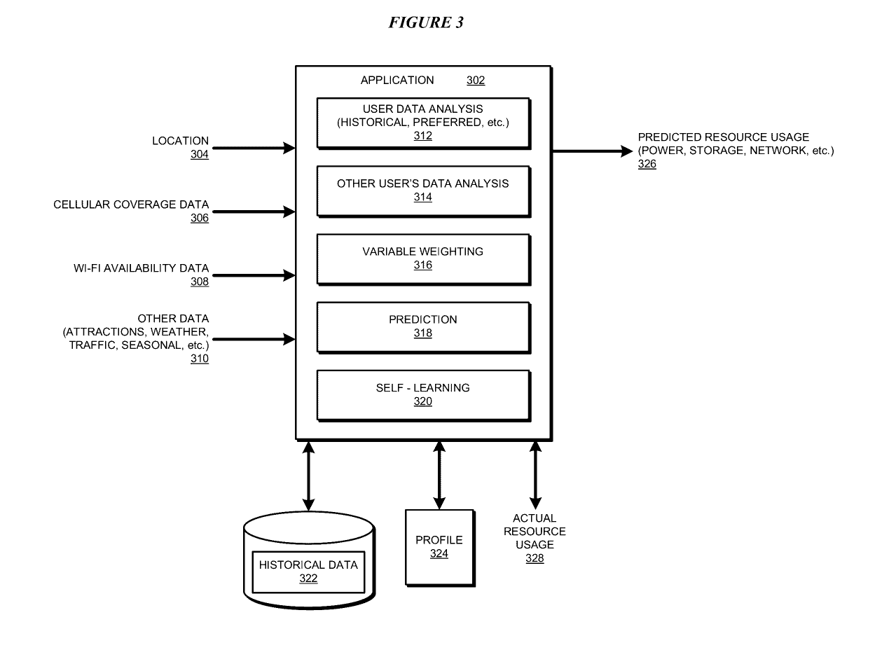

With reference to FIG. 3, this figure depicts a block diagram of an example configuration for predicting location-based resource consumption in mobile devices in accordance with an illustrative embodiment. Application 302 is an example of application 134 in FIG. 1.

Application 302 receives input 304, which provides a location where the resource consumption has to be predicted. One or more data sources provide information about one or more variables, for example, cellular coverage data 306, Wi-Fi availability data 308, and other variable data 310 as described elsewhere in this disclosure.

Component 312 determines whether usage data from the device where application 302 is executing is available in historical data 322. In other words, if the user of the device where application 302 is executing has been to the location before, a usage pattern of the user at the location may be available in historical data 322. When the user's usage data is available, component 312 analyzes such data to estimate the resource consumption for the planned visit to location 304.

When the user's own usage data is not available, or when the usage data of other users will be helpful in the estimation process, component 314 determines whether usage data from other users is available in historical data 322. In other words, if other users of other devices have been to the location before, one or more usage pattern of those users at the location may be available in historical data 322. When other users' usage data is available, component 314 analyzes such data to estimate the resource consumption for the planned visit to location 304.

Component 316 applies weights to the variables that will affect the resource consumption. For example, a prediction model may be pre-configured to use certain variables with certain weights. As another example, a rule may be configured to select some variables and a rule may determine the weights that should be assigned to the selected variables.

As another example, the user may create profile 324 in which the user specifies the user's preferences, which can be used for selecting and weighting the variables. As an example, the user may prefer not to use public Wi-Fi networks even when available. Such a preference can be set in profile 324. Using this preference, component 316 can omit Wi-Fi availability data 308 and assign no weight to the Wi-Fi availability variable. Component 316 may also increase the weight of cellular coverage data 306 because now the user will solely rely on cellular data connectivity because of the preference to avoid public Wi-Fi connectivity.

Profile 324 can be configured with this and many other preferences in a similar manner. A preference can be used to select or avoid a variable, select or adjust a weight of a variable, or a combination thereof, in a similar manner.

Component 318 computes the estimated resource usage based on the analyses of component 312, 314, or both. Component 318 applies the weighted variables produced from component 316 to the estimated resource consumption to predict the resource consumption at location 304 under the circumstances described by variable data 306-310.

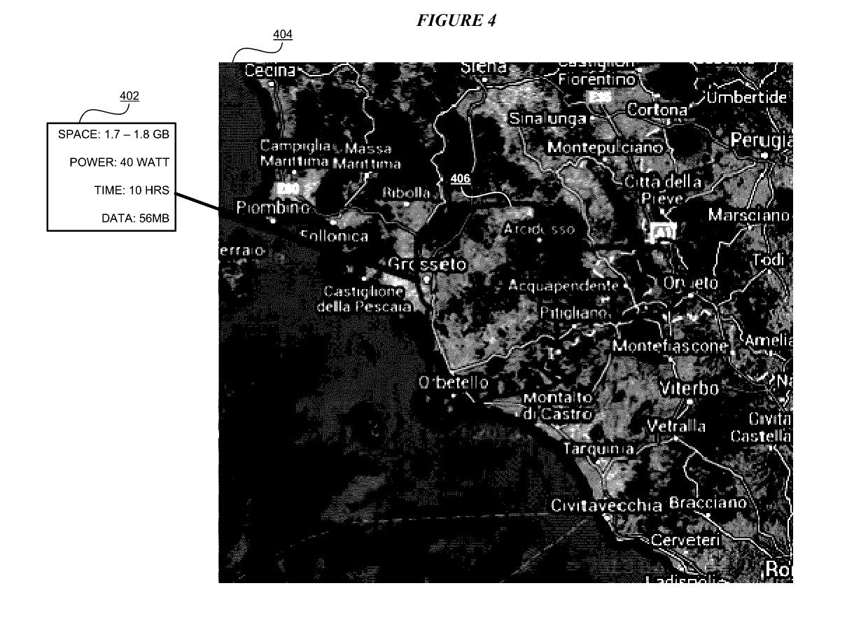

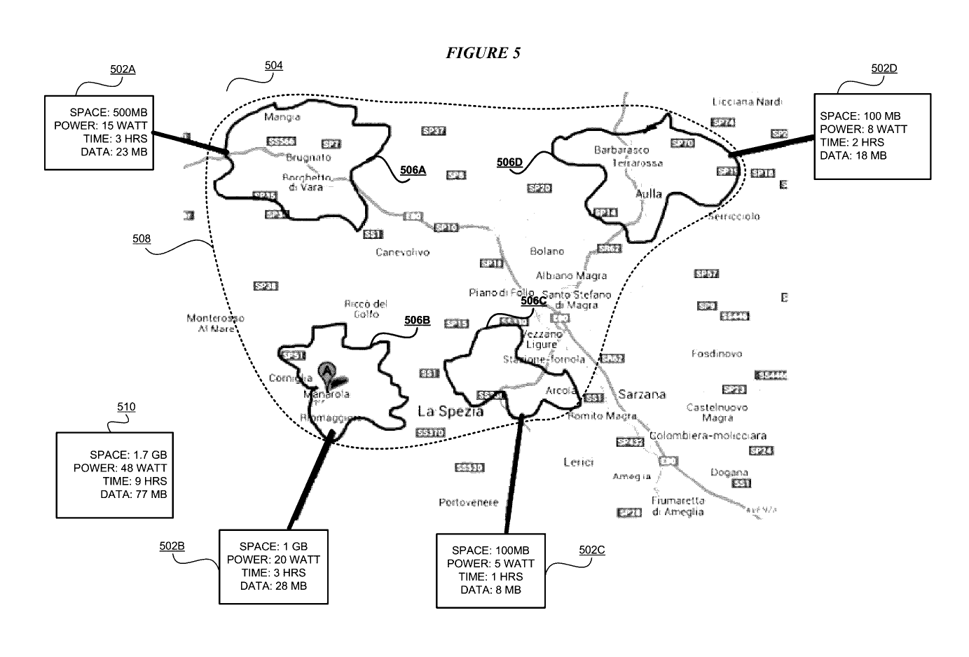

Application 302 outputs predicted resource consumption 326, which is the result of the operation of component 318. In one embodiment, output 326 takes the form of a plot on a graphical map as described elsewhere and as depicted in FIGS. 4 and 5.

When the planned visit to location 304 occurs, application 302 collects actual resource consumption data 328. Component 320 applies a self-learning technique to adjust the prediction model of component 318, a weighting method of component 316, or both. The adjustments improve the accuracy and reliability of output 326 in future predictions.

With reference to FIG. 4, this figure depicts an example plot of a resource usage prediction on a graphical map in accordance with an illustrative embodiment. Prediction 402 is an example of output 326 in FIG. 3.

Map 404 is an example graphical map of an example region. Outline 406 marks an area on map 404. All or part of the area enclosed by outline 406 is an example of location 304 in FIG. 3.

Application 302 in FIG. 3 can be used to render this example plot on a user's mobile device. This example plot allows the user to visualize that if the user—and the device—were to travel to the location marked by outline 406, the user should expect to spend approximately 10 hours according to prediction 402, and expect the device to consume 1.7 GB to 1.8 GB of storage space, expend approximately 40 Watts of power, and utilize approximately 56 MB of data communications over a network.

Such a depiction is very helpful to a user in planning a trip to the region within outline 406. The user can ensure that the device has at least the predicted amount of storage space and power available, and the user's subscription plan or other network access at the location would be usable for at least the predicted amount of data communications. Such prediction and depiction according to an embodiment allow a user to be better prepared for a trip, and reduce the chances of the device unexpectedly depleting the battery, the storage space, or costing data overage charges.

With reference to FIG. 5, this figure depicts another example plot of a resource usage prediction on a graphical map in accordance with an illustrative embodiment. Predictions 502A, 502B, 502C, and 502D are each an example of prediction 402 in FIG. 4.

Map 504 is an example of map 404, zoomed out to depict a larger area of an example region as compared to map 404. Outlines 506A, 506B, 506C, and 506D each mark a location in the manner of outline 406 in FIG. 4. All or some parts of the areas enclosed by outlines 506A-D are examples of location 304 in FIG. 3.

Application 302 in FIG. 3 can be used to render this example plot on a user's mobile device. This example plot allows the user to visualize that if the user—and the device—were to travel to each of the location marked by outlines 506A-D, the user should expect the predicted durations and resource consumptions.

Furthermore, in one embodiment, the application can enclose the areas of outlines 506A-D in one super-outline 508. Prediction 510 shows the aggregates of predictions 502A-D for super-outline 508 that is now in view at the depicted zoom level of map 504. Zooming in to cover, for example, outline 506B presents the user prediction 502B in the segregated manner of FIG. 4.

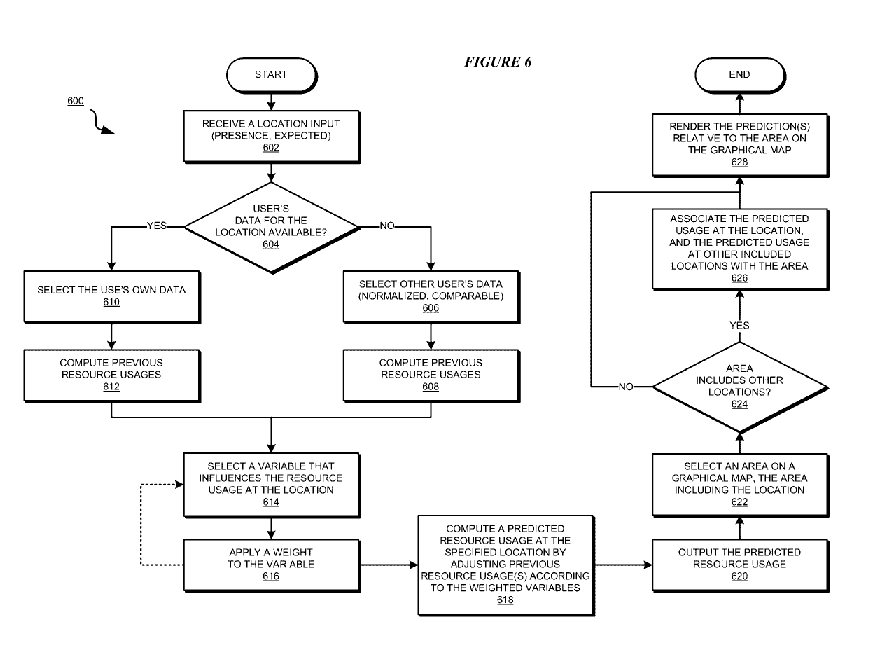

With reference to FIG. 6, this figure depicts a flowchart of an example process for predicting location-based resource consumption in mobile devices in accordance with an illustrative embodiment. Process 600 can be implemented in application 302 in FIG. 3.

The application receives a location input (block 602). For example, the device may be present at the location and the GPS component provides the location input, or the user may be planning a trip and inputs the location of the expected destination.

The application determines whether the user's own usage data is available for the location in a historical data repository (block 604). If the user's own data is not available or usable for the location (“No” path of block 604), the application selects another user's usage data at the location (block 606). The other user's data is normalized, such as by application 105 in FIG. 1, to remove user-specific discrepancies, device-based variations, and other such factors. Using the normalized other user's usage data, the application computes the previous usage of one or more resources (block 608).

If the user's own data is available and usable for the location (“Yes” path of block 604), the application selects the user's usage data at the location (block 610). Using the user's usage data, the application computes the previous usage of one or more resources (block 612). In some cases, the application may execute both paths from block 604.

The application selects a variable that influences the resource usage at the location (block 614). The application applies a weight to the variable (block 616). The application repeats blocks 614 and 616 for as many variables as may be needed in an implementation of a prediction model.

Using the weighted variables from block 616 with the computed previous resource usages from blocks 608, 612, or both, the application computes a predicted resource usage at the location (block 618). For example, the application adjusts a previous resource usage according to one or more weighted variables in a prediction model. The application outputs the predicted usages of one or more resources (block 620).

The application selects an area on a graphical map such that the area includes the location (block 622). The application determines whether the area includes additional locations (block 624). If the area includes other locations (“Yes” path of block 624), the application associates with the area not only the predictions at the location but also the predictions at other locations, if available (block 626). The application renders the prediction(s) relative to the area on the graphical map (block 628). If the area does not include other locations (“No” path of block 624), the application performs the rendering of block 628 with the prediction of block 620. The application ends process 600 thereafter.

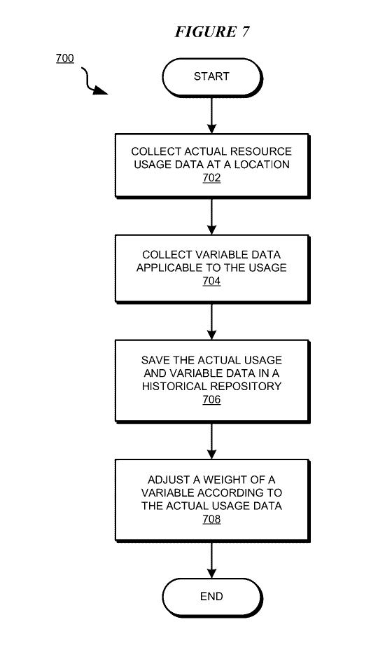

With reference to FIG. 7, this figure depicts a flowchart of an example process for self-learning in accordance with an illustrative embodiment. Process 700 can be implemented in application 302 in FIG. 3.

The application collects actual resource consumption data while operating at a given location, such as at the location of block 602 in FIG. 6 (block 702). The application collects data about one or more variables during the usage as well (block 704).

The application saves the collected usage and variables data in a historical repository (block 706). The application adjusts a weight of a variable according to the actual usage data (block 708). The application ends process 700 thereafter. In some cases, at block 708, the application may also include a new variable into a prediction model, remove a variable from a prediction model, or alter the prediction model in other ways base don't the variables data and the usage data such that the resulting prediction model outputs predicted usages that better fit the actual usages in the future.

Thus, a computer implemented method, system or apparatus, and computer program product are provided in the illustrative embodiments for predicting location-based resource consumption in mobile devices. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for predicting resource usage in a mobile device, the method comprising:
analyzing, at a present time, a historical usage data of a second mobile device, the historical usage data resulting from a usage of the second mobile device at a location at a previous time;
computing a previous consumption of a resource of the second mobile device using the historical usage data;
selecting a variable condition, wherein the variable condition is specific to the location;
applying a weight to the variable condition to form a weighted variable in a prediction model;
adjusting, using the prediction model, to form a predicted consumption of the resource, the previous consumption of the resource according to the weighted variable; and
plotting, on a graphical map, the location and the predicted consumption of the resource.

2. The method of claim 1, further comprising:
predicting, for the location, a first plurality of consumptions corresponding to a first plurality of resources;
predicting, for a second location, a second plurality of consumptions corresponding to a second plurality of resources; and
depicting, on the graphical map, the location, the predicted first plurality of consumptions, the second location, and the predicted second plurality of consumptions.

3. The method of claim 2, further comprising:
aggregating, as a part of the depicting, a predicted consumption from the predicted first plurality with a predicted consumption from the predicted second plurality, wherein the predicted consumption from the predicted first plurality and the predicted consumption from the predicted second plurality corresponds to a common resource of the mobile device.

4. The method of claim 3, further comprising:
detecting a zoom out input relative to the graphical map, the zoom out input causing the location and the second location both being rendered on the mobile device, wherein the aggregating is responsive to the zoom out input.

5. The method of claim 1, further comprising:
selecting the weight, wherein a plurality of variable conditions are specific to the location, wherein a plurality of weights corresponds to the plurality of variable conditions, and wherein the selecting the weight is based on a future time of a visit to the location.

6. The method of claim 1, further comprising:
selecting the weight, wherein a plurality of variable conditions are specific to the location, wherein a plurality of weights corresponds to the plurality of variable conditions, and wherein the selecting the weight is based on a user preference for a visit to the location.

7. The method of claim 1, wherein a plurality of variable conditions are specific to the location, and wherein the selecting the variable condition is based on a future time of a visit to the location.

8. The method of claim 1, wherein a plurality of variable conditions are specific to the location, and wherein the selecting the variable condition is based on a user preference for a visit to the location.

9. The method of claim 1, wherein the second mobile device is the mobile device.

10. The method of claim 1, further comprising:
collecting a usage data of the second mobile device at the location at the previous time;
normalizing the usage data of the second mobile device to remove a characteristic from the usage data of the second mobile device, wherein the characteristic is specific to the second mobile device; and
storing the normalized usage data of the second mobile device as the historical usage data.

11. The method of claim 1, further comprising:
collecting data of an actual consumption of the resource of the mobile device at the location at a future time;
collecting a variable data of the variable condition at the location at the future time;
and
adjusting, to form a modified prediction model, the weight corresponding to the variable condition in the prediction model, such that a second predicted consumption of the resource produced from the modified prediction model is closer to the actual consumption.

12. The method of claim 1, further comprising:
collecting data of an actual consumption of the resource of the mobile device at the location at a future time;
collecting a variable data of a second variable condition at the location at the future time;
and
including, to form a modified prediction model, the second variable condition and a second weight corresponding to the second variable condition in the prediction model, such that a second predicted consumption of the resource produced from the modified prediction model is closer to the actual consumption.

13. The method of claim 1, further comprising:
collecting data of an actual consumption of the resource of the mobile device at the location at a future time;
collecting a variable data of the variable condition at the location at the future time;
collecting a second variable data of a second variable condition at the location at the future time;
and
replacing, to form a modified prediction model, the weighted variable condition with a weighted second variable condition in the prediction model, such that a second predicted consumption of the resource produced from the modified prediction model is closer to the actual consumption.

14. The method of claim 1, wherein the method is embodied in a computer program product comprising one or more computer-readable storage devices and computer-readable program instructions which are stored on the one or more computer-readable tangible storage devices and executed by one or more processors.

15. The method of claim 1, wherein the method is embodied in a computer system comprising one or more processors, one or more computer-readable memories, one or more computer-readable storage devices and program instructions which are stored on the one or more computer-readable storage devices for execution by the one or more processors via the one or more memories and executed by the one or more processors.

16. A computer program product for predicting resource usage in a mobile device, the computer program product comprising one or more computer-readable storage devices, and program instructions stored on at least one of the one or more storage devices, the stored program instructions comprising:
program instructions to analyze, at a present time, a historical usage data of a second mobile device, the historical usage data resulting from a usage of the second mobile device at a location at a previous time;
program instructions to compute a previous consumption of a resource of the second mobile device using the historical usage data;
program instructions to select a variable condition, wherein the variable condition is specific to the location;
program instructions to apply a weight to the variable condition to form a weighted variable in a prediction model;
program instructions to adjust, using the prediction model, to form a predicted consumption of the resource, the previous consumption of the resource according to the weighted variable; and
program instructions to plot, on a graphical map, the location and the predicted consumption of the resource.

17. The computer program product of claim 16, further comprising:
program instructions to predict, for the location, a first plurality of consumptions corresponding to a first plurality of resources;
program instructions to predict, for a second location, a second plurality of consumptions corresponding to a second plurality of resources; and
program instructions to depict, on the graphical map, the location, the predicted first plurality of consumptions, the second location, and the predicted second plurality of consumptions.

18. The computer program product of claim 17, further comprising:
program instructions to aggregate, as a part of the depicting, a predicted consumption from the predicted first plurality with a predicted consumption from the predicted second plurality, wherein the predicted consumption from the predicted first plurality and the predicted consumption from the predicted second plurality corresponds to a common resource of the mobile device.

19. The computer program product of claim 18, further comprising:
program instructions to detect a zoom out input relative to the graphical map, the zoom out input causing the location and the second location both being rendered on the mobile device, wherein the aggregating is responsive to the zoom out input.

20. A computer system for predicting resource usage in a mobile device, the computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to analyze, at a present time, a historical usage data of a second mobile device, the historical usage data resulting from a usage of the second mobile device at a location at a previous time;
program instructions to compute a previous consumption of a resource of the second mobile device using the historical usage data;
program instructions to select a variable condition, wherein the variable condition is specific to the location;
program instructions to apply a weight to the variable condition to form a weighted variable in a prediction model;
program instructions to adjust, using the prediction model, to form a predicted consumption of the resource, the previous consumption of the resource according to the weighted variable; and
program instructions to plot, on a graphical map, the location and the predicted consumption of the resource.
